(19) United States
(12) Patent Application Publication
(10) Pub. No.: US 2025/0369357 A1
(43) Pub. Date: Dec. 4, 2025

(54) TURBINE BLADE

(71) Applicant: Power Systems Mfg., LLC, Juipter, FL (US)

(72) Inventors: Alex Torkaman, Port St. Lucie, FL (US); Douglas James Dietrich, West Palm Beach, FL (US); Elena Pizano, Golden, CO (US)

(21) Appl. No.: 18/679,769

(22) Filed: May 31, 2024

(51) Int. Cl. F01D 5/14; F01D 5/28; F01D 5/30

(52) U.S. Cl. CPC F01D 5/141; F01D 5/288; F05D 2240/301; F05D 2250/74; F05D 2300/17

(57) ABSTRACT

A turbine blade having an airfoil with opposite root and tip ends, opposite pressure and suction sides, and a shape defined substantially in accordance with non-dimensional, scalable Cartesian coordinate values of X, Y and Z set forth in a table. The non-dimensional Cartesian coordinate values of X, Y and Z are convertible to dimensional distances expressed in a unit of distance by multiplying the non-dimensional Cartesian coordinate values of X and Y by a scaling factor in the unit of distance. The non-dimensional Cartesian coordinate values of X and Y are connected by smooth continuing arcs to define a cross-sectional shape of the pressure side and the suction side of the airfoil at each non-dimensional Cartesian coordinate value of Z.

### BACKGROUND

The present disclosure relates to gas turbine engines and, more specifically, to a shape or profile of an airfoil of a turbine blade.

A typical gas turbine engine comprises a compressor, at least one combustor, and a turbine, with the compressor and turbine coupled together through an axial shaft. In operation, air passes through the compressor, where the pressure of the air increases and then passes to a combustion section, where fuel is mixed with the compressed air in one or more combustion chambers and ultimately ignited. The hot combustion gases then pass into the turbine and drive the turbine. As the turbine rotates, the compressor turns, since they are coupled together along a common shaft. The turning of the shaft also drives a generator for electrical applications. The engine must operate within the confines of the environmental regulations for the area in which the engine is located. As a result, more advanced combustion systems have been developed to mix fuel and air more efficiently so as to provide more complete combustion, which results in lower emissions.

As the demand for more powerful and efficient turbine engines continues to increase, it is necessary to improve the efficiency at each stage of the turbine, so as to get the most work possible out of the turbine. To achieve this efficiency improvement, it is necessary to remove any design defects that limit the turbine from achieving its maximum performance. The profile or shape of the airfoils of turbine blades is one area of focus in attempts to improve the turbine performance.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, the present disclosure is directed to a turbine blade comprising an airfoil having a root end and an opposite tip end, a pressure side and an opposite suction side, and an airfoil shape defined substantially in accordance with non-dimensional Cartesian coordinate values of X, Y and Z set forth below in Table 1. The non-dimensional Cartesian coordinate values of X, Y and Z are convertible to dimensional distances expressed in a unit of distance by multiplying the non-dimensional Cartesian coordinate values of X, Y and Z by a scaling factor in the unit of distance. In another embodiment, the scaling factor for the non-dimensional Cartesian coordinate values of X and Y may be different from the scaling factor for the Cartesian coordinate value of Z. The non-dimensional Cartesian coordinate values of Z are values on a z-axis that extends in a radial direction from the root end to the tip end of the airfoil, the non-dimensional Cartesian coordinate values of Y are values on a y-axis that extends from the suction side to the pressure side of the airfoil and is orthogonal to the z-axis, and the non-dimensional Cartesian coordinate values of X are values on an x-axis that is orthogonal to the z-axis and to the y-axis. Adjacent ones of the non-dimensional Cartesian coordinate values of X and Y are connected by smooth continuing arcs to define a cross-sectional shape of the pressure side and the suction side of the airfoil at each non-dimensional Cartesian coordinate value of Z, with the cross-sectional shapes of the pressure side and the suction side of the airfoil at adjacent ones of the non-dimensional Cartesian coordinate values of Z being joined smoothly with one another to form the airfoil shape along a span of the non-dimensional Cartesian coordinate values of Z.

In another aspect, the present disclosure is directed to a plurality of turbine blades as described in the preceding paragraph secured to a rotor disk to form a first stage of a gas turbine.

### BRIEF DESCRIPTION OF THE DRAWINGS

The present disclosure is described in detail below with reference to the attached drawing figures, wherein:

FIG. 1 is a perspective view of a turbine blade according to one embodiment of the disclosure connection to a rotor disk that is shown in fragment; and

FIGS. 2A-2-K depict scatter plots of multiple Cartesian coordinate values of X and Y, each at a corresponding Cartesian coordinate value of Z, using the Cartesian coordinate values of X, Y and Z set forth in Table 1 herein.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

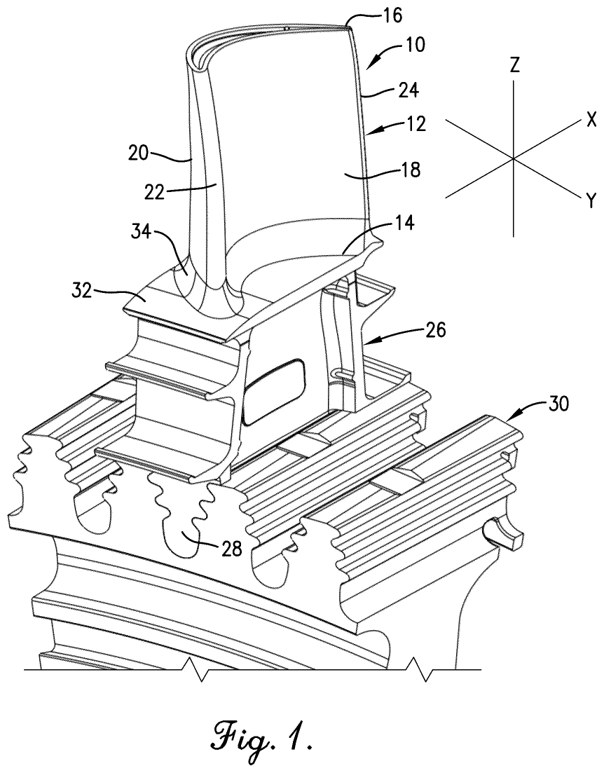

Referring initially to FIG. 1, a turbine rotor bucket or blade 10 in accordance with an embodiment of the present disclosure is shown. The turbine blade 10 in one embodiment is designed to be used in a gas turbine engine as part of a turbine stage in which a plurality of the turbine blades 10 are annularly arrayed about an axis of a turbine rotor shaft and extend in a radially outward direction from the turbine rotor axis. In particular, the turbine blade 10 may be a first stage turbine blade used in a first stage of multiple stages of the turbine.

The turbine blade 10 comprises an airfoil 12 having a first or root end 14 and an opposite, radially outward, second end or tip end 16. The airfoil 12 further comprises a compound curvature profile or shape that includes a concave or pressure side 18 and an opposite convex or suction side 20 that are joined together at a leading edge 22 and an opposite trailing edge 24. The pressure side 18 and suction side 20 of the airfoil 12 can be said to extend radially outwardly in span or in a spanwise direction along a height of the airfoil 12.

The airfoil 12 extends in the radially outwardly direction from a base 26 that includes a radially inwardly positioned attachment 28 that is configured for connection to a rotor disk 30 carried by and rotatable with the turbine rotor shaft (not shown). The base 26 includes a radially outwardly positioned platform 32 to which the root end 14 of the airfoil 12 is attached. A plurality of the turbine blades 10 may be secured by their attachments 28 to the rotor disk 30 in side-by-side relationship in a circumferential row to form a rotor stage, e.g., the first stage of the turbine.

A profile or shape of all or part of the span of the airfoil 12 of the turbine blade 10 in an embodiment of the present disclosure is defined using the non-dimensional Cartesian coordinate values of X, Y and Z set forth in Table 1 below, carried to three decimal places.

The non-dimensional Cartesian coordinate values of Z are values on a z-axis that extends in a radial direction from the root end 14 to the tip end 16 of the airfoil 12, the non-dimensional Cartesian coordinate values of Y are values on a y-axis that extends from the suction side 20 to the pressure side 18 of the airfoil 12 and is orthogonal to the z-axis, and the non-dimensional Cartesian coordinate values of X are values on an x-axis that is orthogonal to the z-axis and to the y-axis. The orientation of the x-axis, y-axis, and z-axis in relation to the airfoil 12 are shown in FIG. 1.

The Cartesian coordinate values of X and Y correspond to locations on the uncoated bare surface of the airfoil 12 at ambient conditions and exclude any coatings that may be applied to the airfoil 12. A set of one hundred Cartesian coordinate values of X and Y for each of eleven different Cartesian coordinate values of Z is set forth in Table 1. Each of the sets of Cartesian coordinate values of X and Y defines discrete, closely spaced locations along the surface of the pressure side 18 and the suction side 20 of the airfoil 12. The Cartesian coordinate values of X and Y in each set may then be connected by smooth continuing arcs to define a cross-sectional shape of the pressure side 18 and the suction side 20 of the airfoil 12 at each Cartesian coordinate value of Z. The cross-sectional shapes of the pressure side 18 and the suction side 20 of the airfoil 12 at adjacent ones of the Cartesian coordinate values of Z may then be joined smoothly with one another to form the airfoil 12 shape along the span of Cartesian coordinate values of Z.

The non-dimensional Cartesian coordinate values of X, Y and Z are convertible to dimensional distances expressed in a unit of distance by multiplying the non-dimensional Cartesian coordinate values of X, Y and Z by a scaling factor in the unit of distance. In another embodiment, the scaling factor may be used only for the non-dimensional Cartesian coordinate values of X and Y and a different scaling factor may be used for the non-dimensional Cartesian coordinate value of Z. As examples, the scaling factor may be equal or substantially equal to 1, or greater than or less than 1, and the unit of distance may be inches or millimeters. In one application, the scaling factor is and is used for each of the non-dimensional Cartesian coordinate values of X, Y and Z and the unit of distance is inches. In other applications, the scaling factor equal or substantially equal to 1 is used for both of the non-dimensional Cartesian coordinate values of X and Y, a different scaling factor that is greater than or less than 1 is used for the non-dimensional Cartesian coordinate value of Z, and the unit of distance is inches.

The non-dimensional Cartesian coordinate values of X, Y, and Z in Table 1 are for the nominal shape of the bare or uncoated airfoil 12. It will be understood that there are normal manufacturing tolerances that should be taken into accounted in determining the shape of the airfoil 12 using the non-dimensional Cartesian coordinate values of X, Y, and Z in Table 1. In other words, the Cartesian coordinate values of X, Y, and Z should be understood to include normal manufacturing tolerances. For example, in one embodiment, when the unit of distance is inches, the Cartesian coordinate values of X, Y, and Z may each include manufacturing tolerances of or about ±0.060 inches. In another embodiment, when the unit of distance is inches, the Cartesian coordinate values of X. Y, and Z may each include manufacturing tolerances of or about ±0.030 inches. Accordingly, as examples, the Cartesian coordinate values of X and Y carried to three decimal places and having a manufacturing tolerance of or about ±0.060 inches or of or about ±0.030 inches may define the shape of the airfoil 12 at each Cartesian coordinate value of Z along the span of the Cartesian coordinate value of Z.

TABLE 1

| X | Y | Z |
|---|---|---|
| −1.913 | 1.350 | 0.000 |
| −1.829 | 1.269 | 0.000 |
| −1.745 | 1.188 | 0.000 |
| −1.660 | 1.108 | 0.000 |
| −1.574 | 1.028 | 0.000 |
| −1.488 | 0.950 | 0.000 |
| −1.400 | 0.872 | 0.000 |
| −1.312 | 0.796 | 0.000 |
| −1.222 | 0.721 | 0.000 |
| −1.132 | 0.647 | 0.000 |
| −1.039 | 0.575 | 0.000 |
| −0.946 | 0.505 | 0.000 |
| −0.851 | 0.437 | 0.000 |
| −0.754 | 0.372 | 0.000 |
| −0.656 | 0.309 | 0.000 |
| −0.556 | 0.248 | 0.000 |
| −0.454 | 0.191 | 0.000 |
| −0.350 | 0.138 | 0.000 |
| −0.244 | 0.088 | 0.000 |
| −0.136 | 0.043 | 0.000 |
| −0.026 | 0.003 | 0.000 |
| 0.085 | −0.032 | 0.000 |
| 0.198 | −0.060 | 0.000 |
| 0.313 | −0.083 | 0.000 |
| 0.429 | −0.097 | 0.000 |
| 0.546 | −0.104 | 0.000 |
| 0.662 | −0.103 | 0.000 |
| 0.779 | −0.092 | 0.000 |
| 0.894 | −0.073 | 0.000 |
| 1.007 | −0.044 | 0.000 |
| 1.118 | −0.006 | 0.000 |
| 1.225 | 0.041 | 0.000 |
| 1.328 | 0.096 | 0.000 |
| 1.426 | 0.158 | 0.000 |
| 1.520 | 0.228 | 0.000 |
| 1.609 | 0.304 | 0.000 |
| 1.692 | 0.386 | 0.000 |
| 1.771 | 0.472 | 0.000 |
| 1.844 | 0.563 | 0.000 |
| 1.916 | 0.655 | 0.000 |
| 2.003 | 0.733 | 0.000 |
| 2.109 | 0.781 | 0.000 |
| 2.220 | 0.760 | 0.000 |
| 2.291 | 0.669 | 0.000 |
| 2.321 | 0.556 | 0.000 |
| 2.321 | 0.440 | 0.000 |
| 2.303 | 0.324 | 0.000 |
| 2.278 | 0.210 | 0.000 |
| 2.245 | 0.098 | 0.000 |
| 2.205 | −0.012 | 0.000 |
| 2.158 | −0.119 | 0.000 |
| 2.106 | −0.223 | 0.000 |
| 2.048 | −0.325 | 0.000 |
| 1.984 | −0.422 | 0.000 |
| 1.913 | −0.516 | 0.000 |
| 1.837 | −0.604 | 0.000 |
| 1.755 | −0.687 | 0.000 |
| 1.668 | −0.765 | 0.000 |
| 1.574 | −0.835 | 0.000 |
| 1.476 | −0.898 | 0.000 |
| 1.373 | −0.953 | 0.000 |
| 1.266 | −0.999 | 0.000 |
| 1.155 | −1.036 | 0.000 |
| 1.041 | −1.063 | 0.000 |
| 0.926 | −1.081 | 0.000 |
| 0.809 | −1.088 | 0.000 |
| 0.692 | −1.087 | 0.000 |
| 0.576 | −1.076 | 0.000 |
| 0.461 | −1.056 | 0.000 |
| 0.347 | −1.029 | 0.000 |
| 0.236 | −0.994 | 0.000 |
| 0.126 | −0.953 | 0.000 |
| 0.020 | −0.906 | 0.000 |
| −0.085 | −0.853 | 0.000 |
| −0.186 | −0.795 | 0.000 |
| −0.285 | −0.733 | 0.000 |
| −0.382 | −0.668 | 0.000 |
| −0.476 | −0.598 | 0.000 |
| −0.567 | −0.525 | 0.000 |
| −0.656 | −0.450 | 0.000 |
| −0.743 | −0.372 | 0.000 |
| −0.828 | −0.292 | 0.000 |
| −0.911 | −0.209 | 0.000 |
| −0.992 | −0.125 | 0.000 |
| −1.072 | −0.040 | 0.000 |
| −1.150 | 0.048 | 0.000 |
| −1.226 | 0.136 | 0.000 |
| −1.301 | 0.226 | 0.000 |
| −1.374 | 0.317 | 0.000 |
| −1.447 | 0.408 | 0.000 |
| −1.518 | 0.501 | 0.000 |
| −1.589 | 0.594 | 0.000 |
| −1.658 | 0.688 | 0.000 |
| −1.727 | 0.782 | 0.000 |
| −1.795 | 0.877 | 0.000 |
| −1.863 | 0.972 | 0.000 |
| −1.930 | 1.068 | 0.000 |
| −1.997 | 1.163 | 0.000 |
| −2.060 | 1.262 | 0.000 |
| −2.021 | 1.363 | 0.000 |
| −1.880 | 1.354 | 0.538 |
| −1.796 | 1.276 | 0.538 |
| −1.713 | 1.197 | 0.538 |
| −1.629 | 1.119 | 0.538 |
| −1.544 | 1.041 | 0.538 |
| −1.459 | 0.964 | 0.538 |
| −1.373 | 0.888 | 0.538 |
| −1.287 | 0.812 | 0.538 |
| −1.199 | 0.738 | 0.538 |
| −1.111 | 0.665 | 0.538 |
| −1.021 | 0.593 | 0.538 |
| −0.931 | 0.523 | 0.538 |
| −0.838 | 0.455 | 0.538 |
| −0.745 | 0.388 | 0.538 |
| −0.650 | 0.324 | 0.538 |
| −0.553 | 0.263 | 0.538 |
| −0.454 | 0.204 | 0.538 |
| −0.354 | 0.149 | 0.538 |
| −0.251 | 0.097 | 0.538 |
| −0.147 | 0.049 | 0.538 |
| −0.040 | 0.006 | 0.538 |
| 0.068 | −0.032 | 0.538 |
| 0.178 | −0.064 | 0.538 |
| 0.290 | −0.089 | 0.538 |
| 0.403 | −0.107 | 0.538 |
| 0.518 | −0.118 | 0.538 |
| 0.632 | −0.119 | 0.538 |
| 0.747 | −0.112 | 0.538 |
| 0.860 | −0.096 | 0.538 |
| 0.972 | −0.070 | 0.538 |
| 1.081 | −0.036 | 0.538 |
| 1.188 | 0.008 | 0.538 |
| 1.290 | 0.060 | 0.538 |
| 1.388 | 0.119 | 0.538 |
| 1.481 | 0.186 | 0.538 |
| 1.570 | 0.259 | 0.538 |
| 1.654 | 0.337 | 0.538 |
| 1.733 | 0.421 | 0.538 |
| 1.806 | 0.509 | 0.538 |
| 1.877 | 0.599 | 0.538 |
| 1.960 | 0.678 | 0.538 |
| 2.062 | 0.729 | 0.538 |
| 2.173 | 0.718 | 0.538 |
| 2.247 | 0.633 | 0.538 |
| 2.280 | 0.523 | 0.538 |
| 2.282 | 0.409 | 0.538 |
| 2.265 | 0.296 | 0.538 |
| 2.241 | 0.183 | 0.538 |
| 2.210 | 0.073 | 0.538 |
| 2.172 | −0.035 | 0.538 |
| 2.128 | −0.141 | 0.538 |
| 2.077 | −0.244 | 0.538 |
| 2.021 | −0.344 | 0.538 |
| 1.958 | −0.440 | 0.538 |
| 1.889 | −0.532 | 0.538 |
| 1.813 | −0.618 | 0.538 |
| 1.732 | −0.699 | 0.538 |
| 1.645 | −0.774 | 0.538 |
| 1.552 | −0.841 | 0.538 |
| 1.454 | −0.901 | 0.538 |
| 1.351 | −0.952 | 0.538 |
| 1.244 | −0.993 | 0.538 |
| 1.134 | −1.026 | 0.538 |
| 1.022 | −1.048 | 0.538 |
| 0.908 | −1.061 | 0.538 |
| 0.793 | −1.065 | 0.538 |
| 0.678 | −1.059 | 0.538 |
| 0.565 | −1.045 | 0.538 |
| 0.452 | −1.023 | 0.538 |
| 0.341 | −0.993 | 0.538 |
| 0.232 | −0.957 | 0.538 |
| 0.126 | −0.914 | 0.538 |
| 0.022 | −0.866 | 0.538 |
| −0.080 | −0.813 | 0.538 |
| −0.179 | −0.755 | 0.538 |
| −0.276 | −0.693 | 0.538 |
| −0.370 | −0.628 | 0.538 |
| −0.462 | −0.559 | 0.538 |
| −0.552 | −0.488 | 0.538 |
| −0.639 | −0.413 | 0.538 |
| −0.724 | −0.336 | 0.538 |
| −0.808 | −0.258 | 0.538 |
| −0.889 | −0.177 | 0.538 |
| −0.969 | −0.094 | 0.538 |
| −1.047 | −0.010 | 0.538 |
| −1.123 | 0.076 | 0.538 |
| −1.198 | 0.163 | 0.538 |
| −1.271 | 0.251 | 0.538 |
| −1.344 | 0.340 | 0.538 |
| −1.415 | 0.430 | 0.538 |
| −1.485 | 0.521 | 0.538 |
| −1.555 | 0.612 | 0.538 |
| −1.623 | 0.704 | 0.538 |
| −1.691 | 0.796 | 0.538 |
| −1.759 | 0.889 | 0.538 |
| −1.826 | 0.982 | 0.538 |
| −1.893 | 1.076 | 0.538 |
| −1.959 | 1.169 | 0.538 |
| −2.022 | 1.265 | 0.538 |
| −1.986 | 1.365 | 0.538 |
| −1.842 | 1.353 | 1.075 |
| −1.761 | 1.275 | 1.075 |
| −1.679 | 1.198 | 1.075 |
| −1.597 | 1.121 | 1.075 |
| −1.514 | 1.045 | 1.075 |
| −1.431 | 0.969 | 1.075 |
| −1.348 | 0.894 | 1.075 |
| −1.263 | 0.819 | 1.075 |
| −1.178 | 0.746 | 1.075 |
| −1.092 | 0.673 | 1.075 |
| −1.004 | 0.602 | 1.075 |
| −0.916 | 0.533 | 1.075 |
| −0.826 | 0.465 | 1.075 |
| −0.735 | 0.399 | 1.075 |
| −0.643 | 0.335 | 1.075 |
| −0.548 | 0.273 | 1.075 |
| −0.453 | 0.214 | 1.075 |
| −0.355 | 0.159 | 1.075 |
| −0.255 | 0.106 | 1.075 |
| −0.154 | 0.058 | 1.075 |
| −0.050 | 0.014 | 1.075 |
| 0.055 | −0.025 | 1.075 |
| 0.163 | −0.058 | 1.075 |
| 0.272 | −0.085 | 1.075 |
| 0.383 | −0.106 | 1.075 |
| 0.495 | −0.118 | 1.075 |
| 0.607 | −0.123 | 1.075 |
| 0.719 | −0.119 | 1.075 |
| 0.831 | −0.106 | 1.075 |
| 0.941 | −0.084 | 1.075 |
| 1.050 | −0.053 | 1.075 |
| 1.155 | −0.013 | 1.075 |
| 1.257 | 0.035 | 1.075 |
| 1.355 | 0.090 | 1.075 |
| 1.448 | 0.153 | 1.075 |
| 1.537 | 0.222 | 1.075 |
| 1.621 | 0.296 | 1.075 |
| 1.700 | 0.376 | 1.075 |
| 1.775 | 0.461 | 1.075 |
| 1.844 | 0.549 | 1.075 |
| 1.925 | 0.627 | 1.075 |
| 2.024 | 0.679 | 1.075 |
| 2.134 | 0.673 | 1.075 |
| 2.211 | 0.593 | 1.075 |
| 2.245 | 0.486 | 1.075 |
| 2.247 | 0.374 | 1.075 |
| 2.230 | 0.263 | 1.075 |
| 2.206 | 0.153 | 1.075 |
| 2.177 | 0.044 | 1.075 |
| 2.140 | −0.062 | 1.075 |
| 2.098 | −0.166 | 1.075 |
| 2.049 | −0.267 | 1.075 |
| 1.993 | −0.365 | 1.075 |
| 1.931 | −0.459 | 1.075 |
| 1.863 | −0.548 | 1.075 |
| 1.788 | −0.632 | 1.075 |
| 1.707 | −0.710 | 1.075 |
| 1.620 | −0.781 | 1.075 |
| 1.527 | −0.845 | 1.075 |
| 1.429 | −0.900 | 1.075 |
| 1.326 | −0.946 | 1.075 |
| 1.220 | −0.983 | 1.075 |
| 1.111 | −1.010 | 1.075 |
| 1.000 | −1.028 | 1.075 |
| 0.887 | −1.037 | 1.075 |
| 0.775 | −1.036 | 1.075 |
| 0.663 | −1.027 | 1.075 |
| 0.552 | −1.009 | 1.075 |
| 0.442 | −0.985 | 1.075 |
| 0.334 | −0.953 | 1.075 |
| 0.228 | −0.916 | 1.075 |
| 0.124 | −0.872 | 1.075 |
| 0.022 | −0.824 | 1.075 |
| −0.077 | −0.771 | 1.075 |
| −0.174 | −0.714 | 1.075 |
| −0.268 | −0.653 | 1.075 |
| −0.361 | −0.588 | 1.075 |
| −0.451 | −0.521 | 1.075 |
| −0.538 | −0.451 | 1.075 |
| −0.624 | −0.378 | 1.075 |
| −0.708 | −0.302 | 1.075 |
| −0.790 | −0.225 | 1.075 |
| −0.869 | −0.146 | 1.075 |
| −0.948 | −0.065 | 1.075 |
| −1.024 | 0.018 | 1.075 |
| −1.099 | 0.101 | 1.075 |
| −1.173 | 0.187 | 1.075 |
| −1.245 | 0.273 | 1.075 |
| −1.316 | 0.360 | 1.075 |
| −1.386 | 0.448 | 1.075 |
| −1.455 | 0.537 | 1.075 |
| −1.523 | 0.627 | 1.075 |
| −1.590 | 0.717 | 1.075 |
| −1.657 | 0.807 | 1.075 |
| −1.724 | 0.898 | 1.075 |
| −1.790 | 0.989 | 1.075 |
| −1.856 | 1.081 | 1.075 |
| −1.921 | 1.172 | 1.075 |
| −1.983 | 1.266 | 1.075 |
| −1.946 | 1.364 | 1.075 |
| −1.804 | 1.350 | 1.613 |
| −1.725 | 1.273 | 1.613 |
| −1.646 | 1.196 | 1.613 |
| −1.566 | 1.120 | 1.613 |
| −1.486 | 1.045 | 1.613 |
| −1.405 | 0.970 | 1.613 |
| −1.323 | 0.896 | 1.613 |
| −1.240 | 0.824 | 1.613 |
| −1.156 | 0.752 | 1.613 |
| −1.072 | 0.681 | 1.613 |
| −0.986 | 0.612 | 1.613 |
| −0.899 | 0.544 | 1.613 |
| −0.810 | 0.478 | 1.613 |
| −0.721 | 0.414 | 1.613 |
| −0.630 | 0.352 | 1.613 |
| −0.537 | 0.292 | 1.613 |
| −0.443 | 0.235 | 1.613 |
| −0.347 | 0.181 | 1.613 |
| −0.250 | 0.129 | 1.613 |
| −0.150 | 0.082 | 1.613 |
| −0.049 | 0.038 | 1.613 |
| 0.054 | −0.001 | 1.613 |
| 0.159 | −0.035 | 1.613 |
| 0.266 | −0.063 | 1.613 |
| 0.374 | −0.085 | 1.613 |
| 0.483 | −0.101 | 1.613 |
| 0.593 | −0.109 | 1.613 |
| 0.703 | −0.109 | 1.613 |
| 0.813 | −0.102 | 1.613 |
| 0.922 | −0.085 | 1.613 |
| 1.029 | −0.060 | 1.613 |
| 1.134 | −0.027 | 1.613 |
| 1.236 | 0.015 | 1.613 |
| 1.334 | 0.065 | 1.613 |
| 1.428 | 0.123 | 1.613 |
| 1.517 | 0.187 | 1.613 |
| 1.601 | 0.259 | 1.613 |
| 1.680 | 0.336 | 1.613 |
| 1.753 | 0.419 | 1.613 |
| 1.821 | 0.506 | 1.613 |
| 1.898 | 0.583 | 1.613 |
| 1.995 | 0.634 | 1.613 |
| 2.103 | 0.630 | 1.613 |
| 2.181 | 0.554 | 1.613 |
| 2.215 | 0.450 | 1.613 |
| 2.216 | 0.340 | 1.613 |
| 2.199 | 0.231 | 1.613 |
| 2.176 | 0.124 | 1.613 |
| 2.147 | 0.017 | 1.613 |
| 2.112 | −0.087 | 1.613 |
| 2.070 | −0.189 | 1.613 |
| 2.021 | −0.288 | 1.613 |
| 1.966 | −0.384 | 1.613 |
| 1.904 | −0.475 | 1.613 |
| 1.836 | −0.561 | 1.613 |
| 1.761 | −0.642 | 1.613 |
| 1.680 | −0.716 | 1.613 |
| 1.592 | −0.783 | 1.613 |
| 1.499 | −0.843 | 1.613 |
| 1.401 | −0.893 | 1.613 |
| 1.299 | −0.935 | 1.613 |
| 1.194 | −0.967 | 1.613 |
| 1.086 | −0.990 | 1.613 |
| 0.977 | −1.003 | 1.613 |
| 0.867 | −1.007 | 1.613 |
| 0.756 | −1.002 | 1.613 |
| 0.647 | −0.990 | 1.613 |
| 0.539 | −0.969 | 1.613 |
| 0.432 | −0.942 | 1.613 |
| 0.327 | −0.909 | 1.613 |
| 0.224 | −0.870 | 1.613 |
| 0.123 | −0.825 | 1.613 |
| 0.024 | −0.776 | 1.613 |
| −0.072 | −0.723 | 1.613 |
| −0.167 | −0.666 | 1.613 |
| −0.259 | −0.606 | 1.613 |
| −0.349 | −0.542 | 1.613 |
| −0.437 | −0.475 | 1.613 |
| −0.523 | −0.406 | 1.613 |
| −0.606 | −0.335 | 1.613 |
| −0.688 | −0.261 | 1.613 |
| −0.769 | −0.185 | 1.613 |
| −0.847 | −0.108 | 1.613 |
| −0.924 | −0.029 | 1.613 |
| −1.000 | 0.051 | 1.613 |
| −1.074 | 0.133 | 1.613 |
| −1.146 | 0.216 | 1.613 |
| −1.218 | 0.300 | 1.613 |
| −1.288 | 0.384 | 1.613 |
| −1.358 | 0.470 | 1.613 |
| −1.426 | 0.557 | 1.613 |
| −1.494 | 0.644 | 1.613 |
| −1.560 | 0.731 | 1.613 |
| −1.627 | 0.820 | 1.613 |
| −1.692 | 0.908 | 1.613 |
| −1.757 | 0.997 | 1.613 |
| −1.822 | 1.087 | 1.613 |
| −1.886 | 1.176 | 1.613 |
| −1.945 | 1.269 | 1.613 |
| −1.906 | 1.364 | 1.613 |
| −1.764 | 1.346 | 2.150 |
| −1.688 | 1.269 | 2.150 |
| −1.612 | 1.192 | 2.150 |
| −1.535 | 1.117 | 2.150 |
| −1.457 | 1.042 | 2.150 |
| −1.378 | 0.969 | 2.150 |
| −1.298 | 0.896 | 2.150 |
| −1.217 | 0.825 | 2.150 |
| −1.134 | 0.755 | 2.150 |
| −1.051 | 0.686 | 2.150 |
| −0.967 | 0.619 | 2.150 |
| −0.881 | 0.553 | 2.150 |
| −0.794 | 0.489 | 2.150 |
| −0.705 | 0.427 | 2.150 |
| −0.616 | 0.367 | 2.150 |
| −0.524 | 0.310 | 2.150 |
| −0.432 | 0.254 | 2.150 |
| −0.338 | 0.202 | 2.150 |
| −0.242 | 0.152 | 2.150 |
| −0.144 | 0.106 | 2.150 |
| −0.045 | 0.063 | 2.150 |
| 0.056 | 0.024 | 2.150 |
| 0.158 | −0.011 | 2.150 |
| 0.262 | −0.040 | 2.150 |
| 0.367 | −0.064 | 2.150 |
| 0.473 | −0.083 | 2.150 |
| 0.581 | −0.095 | 2.150 |
| 0.689 | −0.100 | 2.150 |
| 0.796 | −0.098 | 2.150 |
| 0.904 | −0.088 | 2.150 |
| 1.010 | −0.070 | 2.150 |
| 1.115 | −0.044 | 2.150 |
| 1.217 | −0.009 | 2.150 |
| 1.316 | 0.035 | 2.150 |
| 1.411 | 0.087 | 2.150 |
| 1.500 | 0.147 | 2.150 |
| 1.585 | 0.214 | 2.150 |
| 1.663 | 0.289 | 2.150 |
| 1.735 | 0.369 | 2.150 |
| 1.802 | 0.453 | 2.150 |
| 1.877 | 0.531 | 2.150 |
| 1.971 | 0.583 | 2.150 |
| 2.077 | 0.582 | 2.150 |
| 2.156 | 0.511 | 2.150 |
| 2.191 | 0.410 | 2.150 |
| 2.192 | 0.302 | 2.150 |
| 2.176 | 0.196 | 2.150 |
| 2.154 | 0.090 | 2.150 |
| 2.125 | −0.014 | 2.150 |
| 2.090 | −0.116 | 2.150 |
| 2.049 | −0.216 | 2.150 |
| 2.001 | −0.313 | 2.150 |
| 1.946 | −0.406 | 2.150 |
| 1.884 | −0.494 | 2.150 |
| 1.815 | −0.577 | 2.150 |
| 1.739 | −0.654 | 2.150 |
| 1.657 | −0.724 | 2.150 |
| 1.569 | −0.787 | 2.150 |
| 1.476 | −0.841 | 2.150 |
| 1.378 | −0.886 | 2.150 |
| 1.276 | −0.923 | 2.150 |
| 1.172 | −0.949 | 2.150 |
| 1.065 | −0.967 | 2.150 |
| 0.958 | −0.975 | 2.150 |
| 0.850 | −0.975 | 2.150 |
| 0.742 | −0.967 | 2.150 |
| 0.635 | −0.950 | 2.150 |
| 0.530 | −0.927 | 2.150 |
| 0.426 | −0.898 | 2.150 |
| 0.324 | −0.863 | 2.150 |
| 0.224 | −0.822 | 2.150 |
| 0.126 | −0.777 | 2.150 |
| 0.030 | −0.727 | 2.150 |
| −0.064 | −0.674 | 2.150 |
| −0.156 | −0.617 | 2.150 |
| −0.245 | −0.557 | 2.150 |
| −0.333 | −0.494 | 2.150 |
| −0.419 | −0.428 | 2.150 |
| −0.503 | −0.361 | 2.150 |
| −0.585 | −0.291 | 2.150 |
| −0.666 | −0.219 | 2.150 |
| −0.745 | −0.145 | 2.150 |
| −0.822 | −0.070 | 2.150 |
| −0.898 | 0.007 | 2.150 |
| −0.973 | 0.085 | 2.150 |
| −1.046 | 0.164 | 2.150 |
| −1.118 | 0.245 | 2.150 |
| −1.189 | 0.326 | 2.150 |
| −1.259 | 0.408 | 2.150 |
| −1.328 | 0.491 | 2.150 |
| −1.396 | 0.575 | 2.150 |
| −1.464 | 0.660 | 2.150 |
| −1.530 | 0.745 | 2.150 |
| −1.595 | 0.831 | 2.150 |
| −1.660 | 0.917 | 2.150 |
| −1.724 | 1.004 | 2.150 |
| −1.787 | 1.091 | 2.150 |
| −1.850 | 1.180 | 2.150 |
| −1.906 | 1.271 | 2.150 |
| −1.863 | 1.362 | 2.150 |
| −1.723 | 1.339 | 2.688 |
| −1.650 | 1.262 | 2.688 |
| −1.576 | 1.187 | 2.688 |
| −1.501 | 1.112 | 2.688 |
| −1.426 | 1.038 | 2.688 |
| −1.349 | 0.965 | 2.688 |
| −1.271 | 0.893 | 2.688 |
| −1.192 | 0.823 | 2.688 |
| −1.112 | 0.753 | 2.688 |
| −1.031 | 0.686 | 2.688 |
| −0.949 | 0.619 | 2.688 |
| −0.865 | 0.555 | 2.688 |
| −0.780 | 0.492 | 2.688 |
| −0.694 | 0.430 | 2.688 |
| −0.606 | 0.371 | 2.688 |
| −0.517 | 0.314 | 2.688 |
| −0.426 | 0.260 | 2.688 |
| −0.334 | 0.208 | 2.688 |
| −0.240 | 0.158 | 2.688 |
| −0.145 | 0.112 | 2.688 |
| −0.048 | 0.069 | 2.688 |
| 0.050 | 0.030 | 2.688 |
| 0.150 | −0.005 | 2.688 |
| 0.251 | −0.036 | 2.688 |
| 0.354 | −0.062 | 2.688 |
| 0.457 | −0.083 | 2.688 |
| 0.562 | −0.098 | 2.688 |
| 0.667 | −0.107 | 2.688 |
| 0.773 | −0.109 | 2.688 |
| 0.879 | −0.104 | 2.688 |
| 0.984 | −0.092 | 2.688 |
| 1.088 | −0.071 | 2.688 |
| 1.190 | −0.043 | 2.688 |
| 1.289 | −0.005 | 2.688 |
| 1.384 | 0.041 | 2.688 |
| 1.475 | 0.095 | 2.688 |
| 1.561 | 0.156 | 2.688 |
| 1.641 | 0.225 | 2.688 |
| 1.716 | 0.300 | 2.688 |
| 1.785 | 0.380 | 2.688 |
| 1.856 | 0.458 | 2.688 |
| 1.946 | 0.512 | 2.688 |
| 2.050 | 0.518 | 2.688 |
| 2.134 | 0.457 | 2.688 |
| 2.173 | 0.359 | 2.688 |
| 2.176 | 0.254 | 2.688 |
| 2.162 | 0.149 | 2.688 |
| 2.141 | 0.045 | 2.688 |
| 2.114 | −0.057 | 2.688 |
| 2.080 | −0.157 | 2.688 |
| 2.040 | −0.255 | 2.688 |
| 1.992 | −0.349 | 2.688 |
| 1.937 | −0.440 | 2.688 |
| 1.874 | −0.525 | 2.688 |
| 1.804 | −0.604 | 2.688 |
| 1.727 | −0.677 | 2.688 |
| 1.644 | −0.742 | 2.688 |
| 1.555 | −0.799 | 2.688 |
| 1.461 | −0.847 | 2.688 |
| 1.362 | −0.886 | 2.688 |
| 1.260 | −0.915 | 2.688 |
| 1.157 | −0.936 | 2.688 |
| 1.052 | −0.947 | 2.688 |
| 0.946 | −0.950 | 2.688 |
| 0.840 | −0.944 | 2.688 |
| 0.735 | −0.932 | 2.688 |
| 0.631 | −0.912 | 2.688 |
| 0.528 | −0.886 | 2.688 |
| 0.427 | −0.855 | 2.688 |
| 0.328 | −0.818 | 2.688 |
| 0.231 | −0.777 | 2.688 |
| 0.135 | −0.731 | 2.688 |
| 0.042 | −0.682 | 2.688 |
| −0.050 | −0.629 | 2.688 |
| −0.139 | −0.572 | 2.688 |
| −0.227 | −0.513 | 2.688 |
| −0.313 | −0.452 | 2.688 |
| −0.397 | −0.388 | 2.688 |
| −0.480 | −0.322 | 2.688 |
| −0.561 | −0.253 | 2.688 |
| −0.640 | −0.183 | 2.688 |
| −0.718 | −0.112 | 2.688 |
| −0.795 | −0.039 | 2.688 |
| −0.870 | 0.036 | 2.688 |
| −0.944 | 0.111 | 2.688 |
| −1.016 | 0.188 | 2.688 |
| −1.088 | 0.266 | 2.688 |
| −1.158 | 0.345 | 2.688 |
| −1.228 | 0.425 | 2.688 |
| −1.296 | 0.506 | 2.688 |
| −1.363 | 0.588 | 2.688 |
| −1.430 | 0.670 | 2.688 |
| −1.495 | 0.753 | 2.688 |
| −1.560 | 0.837 | 2.688 |
| −1.624 | 0.921 | 2.688 |
| −1.687 | 1.007 | 2.688 |
| −1.749 | 1.092 | 2.688 |
| −1.810 | 1.179 | 2.688 |
| −1.863 | 1.269 | 2.688 |
| −1.820 | 1.357 | 2.688 |
| −1.681 | 1.333 | 3.225 |
| −1.609 | 1.258 | 3.225 |
| −1.537 | 1.183 | 3.225 |
| −1.464 | 1.110 | 3.225 |
| −1.390 | 1.037 | 3.225 |
| −1.316 | 0.965 | 3.225 |
| −1.240 | 0.893 | 3.225 |
| −1.164 | 0.823 | 3.225 |
| −1.086 | 0.754 | 3.225 |
| −1.008 | 0.687 | 3.225 |
| −0.928 | 0.620 | 3.225 |
| −0.847 | 0.556 | 3.225 |
| −0.765 | 0.493 | 3.225 |
| −0.681 | 0.431 | 3.225 |
| −0.596 | 0.372 | 3.225 |
| −0.509 | 0.314 | 3.225 |
| −0.422 | 0.259 | 3.225 |
| −0.332 | 0.207 | 3.225 |
| −0.241 | 0.157 | 3.225 |
| −0.149 | 0.110 | 3.225 |
| −0.055 | 0.066 | 3.225 |
| 0.041 | 0.025 | 3.225 |
| 0.138 | −0.011 | 3.225 |
| 0.236 | −0.044 | 3.225 |
| 0.336 | −0.072 | 3.225 |
| 0.437 | −0.095 | 3.225 |
| 0.539 | −0.113 | 3.225 |
| 0.642 | −0.126 | 3.225 |
| 0.746 | −0.132 | 3.225 |
| 0.849 | −0.131 | 3.225 |
| 0.953 | −0.123 | 3.225 |
| 1.055 | −0.108 | 3.225 |
| 1.157 | −0.085 | 3.225 |
| 1.255 | −0.054 | 3.225 |
| 1.351 | −0.015 | 3.225 |
| 1.444 | 0.032 | 3.225 |
| 1.532 | 0.087 | 3.225 |
| 1.615 | 0.149 | 3.225 |
| 1.693 | 0.218 | 3.225 |
| 1.766 | 0.292 | 3.225 |
| 1.836 | 0.368 | 3.225 |
| 1.922 | 0.425 | 3.225 |
| 2.023 | 0.441 | 3.225 |
| 2.112 | 0.393 | 3.225 |
| 2.159 | 0.301 | 3.225 |
| 2.167 | 0.198 | 3.225 |
| 2.154 | 0.096 | 3.225 |
| 2.134 | −0.006 | 3.225 |
| 2.108 | −0.107 | 3.225 |
| 2.075 | −0.205 | 3.225 |
| 2.035 | −0.301 | 3.225 |
| 1.987 | −0.393 | 3.225 |
| 1.931 | −0.480 | 3.225 |
| 1.868 | −0.562 | 3.225 |
| 1.797 | −0.637 | 3.225 |
| 1.718 | −0.705 | 3.225 |
| 1.633 | −0.765 | 3.225 |
| 1.543 | −0.815 | 3.225 |
| 1.448 | −0.857 | 3.225 |
| 1.349 | −0.888 | 3.225 |
| 1.248 | −0.911 | 3.225 |
| 1.145 | −0.925 | 3.225 |
| 1.042 | −0.930 | 3.225 |
| 0.938 | −0.927 | 3.225 |
| 0.835 | −0.917 | 3.225 |
| 0.732 | −0.900 | 3.225 |
| 0.631 | −0.877 | 3.225 |
| 0.531 | −0.849 | 3.225 |
| 0.433 | −0.816 | 3.225 |
| 0.337 | −0.778 | 3.225 |
| 0.242 | −0.736 | 3.225 |
| 0.149 | −0.690 | 3.225 |
| 0.057 | −0.641 | 3.225 |
| −0.032 | −0.588 | 3.225 |
| −0.120 | −0.533 | 3.225 |
| −0.206 | −0.475 | 3.225 |
| −0.290 | −0.415 | 3.225 |
| −0.373 | −0.352 | 3.225 |
| −0.454 | −0.288 | 3.225 |
| −0.534 | −0.222 | 3.225 |
| −0.612 | −0.153 | 3.225 |
| −0.689 | −0.084 | 3.225 |
| −0.765 | −0.013 | 3.225 |
| −0.839 | 0.060 | 3.225 |
| −0.912 | 0.134 | 3.225 |
| −0.984 | 0.209 | 3.225 |
| −1.054 | 0.285 | 3.225 |
| −1.124 | 0.362 | 3.225 |
| −1.192 | 0.440 | 3.225 |
| −1.259 | 0.519 | 3.225 |
| −1.326 | 0.598 | 3.225 |
| −1.391 | 0.679 | 3.225 |
| −1.456 | 0.760 | 3.225 |
| −1.519 | 0.842 | 3.225 |
| −1.582 | 0.925 | 3.225 |
| −1.644 | 1.008 | 3.225 |
| −1.705 | 1.091 | 3.225 |
| −1.766 | 1.176 | 3.225 |
| −1.819 | 1.264 | 3.225 |
| −1.776 | 1.350 | 3.225 |
| −1.638 | 1.332 | 3.763 |
| −1.566 | 1.260 | 3.763 |
| −1.494 | 1.188 | 3.763 |
| −1.422 | 1.116 | 3.763 |
| −1.349 | 1.045 | 3.763 |
| −1.276 | 0.974 | 3.763 |
| −1.202 | 0.904 | 3.763 |

| | | |
|---|---|---|
| −1.128 | 0.835 | 3.763 |
| −1.052 | 0.767 | 3.763 |
| −0.976 | 0.700 | 3.763 |
| −0.899 | 0.634 | 3.763 |
| −0.820 | 0.570 | 3.763 |
| −0.740 | 0.506 | 3.763 |
| −0.660 | 0.445 | 3.763 |
| −0.577 | 0.385 | 3.763 |
| −0.494 | 0.327 | 3.763 |
| −0.409 | 0.271 | 3.763 |
| −0.323 | 0.217 | 3.763 |
| −0.235 | 0.165 | 3.763 |
| −0.146 | 0.116 | 3.763 |
| −0.055 | 0.070 | 3.763 |
| 0.037 | 0.028 | 3.763 |
| 0.131 | −0.012 | 3.763 |
| 0.226 | −0.047 | 3.763 |
| 0.323 | −0.078 | 3.763 |
| 0.421 | −0.105 | 3.763 |
| 0.520 | −0.127 | 3.763 |
| 0.620 | −0.144 | 3.763 |
| 0.721 | −0.155 | 3.763 |
| 0.823 | −0.159 | 3.763 |
| 0.924 | −0.157 | 3.763 |
| 1.026 | −0.148 | 3.763 |
| 1.126 | −0.132 | 3.763 |
| 1.225 | −0.108 | 3.763 |
| 1.321 | −0.076 | 3.763 |
| 1.415 | −0.036 | 3.763 |
| 1.505 | 0.011 | 3.763 |
| 1.591 | 0.065 | 3.763 |
| 1.672 | 0.127 | 3.763 |
| 1.748 | 0.194 | 3.763 |
| 1.818 | 0.268 | 3.763 |
| 1.898 | 0.329 | 3.763 |
| 1.995 | 0.358 | 3.763 |
| 2.090 | 0.329 | 3.763 |
| 2.147 | 0.246 | 3.763 |
| 2.163 | 0.146 | 3.763 |
| 2.151 | 0.045 | 3.763 |
| 2.130 | −0.054 | 3.763 |
| 2.102 | −0.152 | 3.763 |
| 2.068 | −0.248 | 3.763 |
| 2.026 | −0.341 | 3.763 |
| 1.977 | −0.429 | 3.763 |
| 1.919 | −0.513 | 3.763 |
| 1.854 | −0.591 | 3.763 |
| 1.781 | −0.662 | 3.763 |
| 1.702 | −0.725 | 3.763 |
| 1.616 | −0.780 | 3.763 |
| 1.525 | −0.825 | 3.763 |
| 1.430 | −0.861 | 3.763 |
| 1.332 | −0.887 | 3.763 |
| 1.232 | −0.905 | 3.763 |
| 1.130 | −0.914 | 3.763 |
| 1.029 | −0.914 | 3.763 |
| 0.927 | −0.908 | 3.763 |
| 0.827 | −0.894 | 3.763 |
| 0.727 | −0.874 | 3.763 |
| 0.628 | −0.849 | 3.763 |
| 0.531 | −0.818 | 3.763 |
| 0.436 | −0.783 | 3.763 |
| 0.342 | −0.744 | 3.763 |
| 0.250 | −0.701 | 3.763 |
| 0.160 | −0.655 | 3.763 |
| 0.071 | −0.605 | 3.763 |
| −0.016 | −0.552 | 3.763 |
| −0.102 | −0.497 | 3.763 |
| −0.186 | −0.440 | 3.763 |
| −0.268 | −0.380 | 3.763 |
| −0.349 | −0.319 | 3.763 |
| −0.428 | −0.255 | 3.763 |
| −0.506 | −0.190 | 3.763 |
| −0.582 | −0.123 | 3.763 |
| −0.658 | −0.054 | 3.763 |
| −0.732 | 0.016 | 3.763 |
| −0.804 | 0.087 | 3.763 |
| −0.876 | 0.159 | 3.763 |
| −0.946 | 0.232 | 3.763 |
| −1.015 | 0.307 | 3.763 |
| −1.084 | 0.382 | 3.763 |
| −1.151 | 0.458 | 3.763 |
| −1.217 | 0.535 | 3.763 |
| −1.283 | 0.613 | 3.763 |
| −1.347 | 0.692 | 3.763 |
| −1.411 | 0.771 | 3.763 |
| −1.474 | 0.851 | 3.763 |
| −1.537 | 0.931 | 3.763 |
| −1.598 | 1.012 | 3.763 |
| −1.660 | 1.093 | 3.763 |
| −1.720 | 1.174 | 3.763 |
| −1.773 | 1.260 | 3.763 |
| −1.732 | 1.346 | 3.763 |
| −1.593 | 1.324 | 4.300 |
| −1.520 | 1.257 | 4.300 |
| −1.447 | 1.189 | 4.300 |
| −1.375 | 1.120 | 4.300 |
| −1.302 | 1.052 | 4.300 |
| −1.230 | 0.984 | 4.300 |
| −1.157 | 0.916 | 4.300 |
| −1.083 | 0.849 | 4.300 |
| −1.009 | 0.783 | 4.300 |
| −0.934 | 0.717 | 4.300 |
| −0.858 | 0.652 | 4.300 |
| −0.782 | 0.589 | 4.300 |
| −0.704 | 0.526 | 4.300 |
| −0.626 | 0.465 | 4.300 |
| −0.546 | 0.405 | 4.300 |
| −0.466 | 0.346 | 4.300 |
| −0.384 | 0.289 | 4.300 |
| −0.301 | 0.234 | 4.300 |
| −0.216 | 0.181 | 4.300 |
| −0.131 | 0.131 | 4.300 |
| −0.043 | 0.083 | 4.300 |
| 0.045 | 0.037 | 4.300 |
| 0.135 | −0.005 | 4.300 |
| 0.227 | −0.044 | 4.300 |
| 0.320 | −0.080 | 4.300 |
| 0.414 | −0.111 | 4.300 |
| 0.510 | −0.138 | 4.300 |
| 0.607 | −0.160 | 4.300 |
| 0.705 | −0.177 | 4.300 |
| 0.804 | −0.188 | 4.300 |
| 0.904 | −0.193 | 4.300 |
| 1.003 | −0.191 | 4.300 |
| 1.103 | −0.183 | 4.300 |
| 1.201 | −0.166 | 4.300 |
| 1.298 | −0.143 | 4.300 |
| 1.392 | −0.111 | 4.300 |
| 1.484 | −0.072 | 4.300 |
| 1.572 | −0.026 | 4.300 |
| 1.655 | 0.029 | 4.300 |
| 1.733 | 0.091 | 4.300 |
| 1.805 | 0.160 | 4.300 |
| 1.880 | 0.225 | 4.300 |
| 1.970 | 0.265 | 4.300 |
| 2.068 | 0.258 | 4.300 |
| 2.135 | 0.188 | 4.300 |
| 2.160 | 0.092 | 4.300 |
| 2.153 | −0.007 | 4.300 |
| 2.129 | −0.104 | 4.300 |
| 2.098 | −0.199 | 4.300 |
| 2.060 | −0.291 | 4.300 |
| 2.015 | −0.380 | 4.300 |
| 1.963 | −0.464 | 4.300 |
| 1.903 | −0.544 | 4.300 |
| 1.836 | −0.617 | 4.300 |
| 1.762 | −0.684 | 4.300 |
| 1.682 | −0.743 | 4.300 |
| 1.596 | −0.793 | 4.300 |
| 1.505 | −0.834 | 4.300 |
| 1.411 | −0.866 | 4.300 |
| 1.314 | −0.889 | 4.300 |
| 1.215 | −0.902 | 4.300 |
| 1.116 | −0.908 | 4.300 |
| 1.016 | −0.906 | 4.300 |
| 0.917 | −0.896 | 4.300 |
| 0.819 | −0.880 | 4.300 |
| 0.722 | −0.858 | 4.300 |
| 0.626 | −0.830 | 4.300 |
| 0.532 | −0.798 | 4.300 |
| 0.439 | −0.761 | 4.300 |
| 0.348 | −0.720 | 4.300 |
| 0.259 | −0.676 | 4.300 |
| 0.172 | −0.628 | 4.300 |
| 0.086 | −0.578 | 4.300 |
| 0.001 | −0.525 | 4.300 |
| −0.081 | −0.469 | 4.300 |
| −0.162 | −0.412 | 4.300 |
| −0.242 | −0.352 | 4.300 |
| −0.320 | −0.290 | 4.300 |
| −0.397 | −0.227 | 4.300 |
| −0.473 | −0.162 | 4.300 |
| −0.547 | −0.096 | 4.300 |
| −0.620 | −0.028 | 4.300 |
| −0.692 | 0.041 | 4.300 |
| −0.763 | 0.110 | 4.300 |
| −0.833 | 0.181 | 4.300 |
| −0.902 | 0.253 | 4.300 |
| −0.970 | 0.326 | 4.300 |
| −1.037 | 0.400 | 4.300 |
| −1.103 | 0.474 | 4.300 |
| −1.169 | 0.549 | 4.300 |
| −1.234 | 0.625 | 4.300 |
| −1.298 | 0.701 | 4.300 |
| −1.361 | 0.778 | 4.300 |
| −1.424 | 0.855 | 4.300 |
| −1.487 | 0.932 | 4.300 |
| −1.549 | 1.010 | 4.300 |
| −1.611 | 1.088 | 4.300 |
| −1.672 | 1.166 | 4.300 |
| −1.726 | 1.249 | 4.300 |
| −1.686 | 1.334 | 4.300 |
| −1.543 | 1.287 | 4.838 |
| −1.469 | 1.224 | 4.838 |
| −1.396 | 1.160 | 4.838 |
| −1.323 | 1.095 | 4.838 |
| −1.250 | 1.030 | 4.838 |
| −1.178 | 0.966 | 4.838 |
| −1.105 | 0.901 | 4.838 |
| −1.032 | 0.837 | 4.838 |
| −0.958 | 0.773 | 4.838 |
| −0.884 | 0.710 | 4.838 |
| −0.809 | 0.648 | 4.838 |
| −0.734 | 0.586 | 4.838 |
| −0.658 | 0.525 | 4.838 |
| −0.582 | 0.465 | 4.838 |
| −0.504 | 0.406 | 4.838 |
| −0.426 | 0.348 | 4.838 |
| −0.347 | 0.291 | 4.838 |
| −0.267 | 0.236 | 4.838 |
| −0.185 | 0.183 | 4.838 |
| −0.103 | 0.131 | 4.838 |
| −0.019 | 0.081 | 4.838 |
| 0.066 | 0.034 | 4.838 |
| 0.152 | −0.011 | 4.838 |
| 0.240 | −0.053 | 4.838 |
| 0.329 | −0.093 | 4.838 |
| 0.420 | −0.128 | 4.838 |
| 0.512 | −0.160 | 4.838 |
| 0.605 | −0.188 | 4.838 |
| 0.700 | −0.210 | 4.838 |
| 0.796 | −0.228 | 4.838 |
| 0.892 | −0.239 | 4.838 |
| 0.989 | −0.245 | 4.838 |
| 1.087 | −0.243 | 4.838 |
| 1.184 | −0.234 | 4.838 |
| 1.279 | −0.217 | 4.838 |
| 1.374 | −0.192 | 4.838 |
| 1.465 | −0.159 | 4.838 |
| 1.554 | −0.119 | 4.838 |
| 1.639 | −0.071 | 4.838 |
| 1.719 | −0.016 | 4.838 |
| 1.795 | 0.045 | 4.838 |
| 1.868 | 0.109 | 4.838 |
| 1.954 | 0.154 | 4.838 |
| 2.050 | 0.161 | 4.838 |
| 2.127 | 0.107 | 4.838 |
| 2.160 | 0.016 | 4.838 |
| 2.157 | −0.081 | 4.838 |
| 2.131 | −0.175 | 4.838 |
| 2.097 | −0.266 | 4.838 |
| 2.056 | −0.354 | 4.838 |
| 2.008 | −0.439 | 4.838 |
| 1.953 | −0.519 | 4.838 |
| 1.892 | −0.595 | 4.838 |
| 1.823 | −0.664 | 4.838 |
| 1.748 | −0.726 | 4.838 |
| 1.668 | −0.781 | 4.838 |
| 1.582 | −0.826 | 4.838 |
| 1.492 | −0.863 | 4.838 |
| 1.399 | −0.891 | 4.838 |
| 1.303 | −0.909 | 4.838 |
| 1.206 | −0.919 | 4.838 |
| 1.109 | −0.920 | 4.838 |
| 1.012 | −0.913 | 4.838 |
| 0.915 | −0.900 | 4.838 |
| 0.820 | −0.881 | 4.838 |
| 0.726 | −0.855 | 4.838 |
| 0.633 | −0.825 | 4.838 |
| 0.542 | −0.790 | 4.838 |
| 0.453 | −0.752 | 4.838 |
| 0.365 | −0.709 | 4.838 |
| 0.279 | −0.664 | 4.838 |
| 0.195 | −0.615 | 4.838 |
| 0.112 | −0.564 | 4.838 |
| 0.031 | −0.511 | 4.838 |
| −0.049 | −0.455 | 4.838 |
| −0.128 | −0.398 | 4.838 |
| −0.205 | −0.339 | 4.838 |
| −0.281 | −0.278 | 4.838 |
| −0.356 | −0.215 | 4.838 |
| −0.429 | −0.152 | 4.838 |
| −0.502 | −0.087 | 4.838 |
| −0.573 | −0.021 | 4.838 |
| −0.644 | 0.047 | 4.838 |
| −0.713 | 0.115 | 4.838 |
| −0.782 | 0.184 | 4.838 |
| −0.850 | 0.254 | 4.838 |
| −0.917 | 0.324 | 4.838 |
| −0.983 | 0.395 | 4.838 |
| −1.049 | 0.467 | 4.838 |
| −1.114 | 0.539 | 4.838 |
| −1.179 | 0.612 | 4.838 |
| −1.243 | 0.685 | 4.838 |
| −1.307 | 0.759 | 4.838 |
| −1.370 | 0.833 | 4.838 |
| −1.433 | 0.907 | 4.838 |
| −1.496 | 0.982 | 4.838 |
| −1.558 | 1.056 | 4.838 |
| −1.621 | 1.131 | 4.838 |
| −1.673 | 1.211 | 4.838 |
| −1.634 | 1.294 | 4.838 |
| −1.487 | 1.209 | 5.375 |
| −1.414 | 1.149 | 5.375 |
| −1.341 | 1.088 | 5.375 |
| −1.268 | 1.027 | 5.375 |
| −1.195 | 0.966 | 5.375 |
| −1.123 | 0.905 | 5.375 |
| −1.050 | 0.844 | 5.375 |
| −0.977 | 0.784 | 5.375 |
| −0.903 | 0.724 | 5.375 |
| −0.830 | 0.664 | 5.375 |
| −0.756 | 0.604 | 5.375 |
| −0.681 | 0.545 | 5.375 |
| −0.607 | 0.487 | 5.375 |
| −0.531 | 0.430 | 5.375 |
| −0.455 | 0.373 | 5.375 |
| −0.379 | 0.317 | 5.375 |
| −0.301 | 0.262 | 5.375 |
| −0.223 | 0.208 | 5.375 |
| −0.144 | 0.155 | 5.375 |
| −0.065 | 0.104 | 5.375 |
| 0.016 | 0.054 | 5.375 |
| 0.098 | 0.006 | 5.375 |
| 0.181 | −0.040 | 5.375 |
| 0.265 | −0.084 | 5.375 |
| 0.350 | −0.126 | 5.375 |
| 0.436 | −0.165 | 5.375 |
| 0.524 | −0.200 | 5.375 |
| 0.614 | −0.232 | 5.375 |
| 0.704 | −0.260 | 5.375 |
| 0.796 | −0.283 | 5.375 |
| 0.890 | −0.300 | 5.375 |
| 0.984 | −0.311 | 5.375 |
| 1.079 | −0.314 | 5.375 |
| 1.173 | −0.310 | 5.375 |
| 1.267 | −0.297 | 5.375 |
| 1.360 | −0.277 | 5.375 |
| 1.450 | −0.248 | 5.375 |
| 1.538 | −0.211 | 5.375 |
| 1.623 | −0.169 | 5.375 |
| 1.705 | −0.122 | 5.375 |
| 1.785 | −0.070 | 5.375 |
| 1.862 | −0.016 | 5.375 |
| 1.946 | 0.027 | 5.375 |
| 2.040 | 0.037 | 5.375 |
| 2.123 | −0.006 | 5.375 |
| 2.162 | −0.091 | 5.375 |
| 2.161 | −0.185 | 5.375 |
| 2.132 | −0.275 | 5.375 |
| 2.095 | −0.363 | 5.375 |
| 2.052 | −0.447 | 5.375 |
| 2.003 | −0.528 | 5.375 |
| 1.947 | −0.605 | 5.375 |
| 1.886 | −0.677 | 5.375 |
| 1.817 | −0.743 | 5.375 |
| 1.743 | −0.801 | 5.375 |
| 1.663 | −0.852 | 5.375 |
| 1.577 | −0.893 | 5.375 |
| 1.488 | −0.925 | 5.375 |
| 1.395 | −0.946 | 5.375 |
| 1.301 | −0.958 | 5.375 |
| 1.207 | −0.961 | 5.375 |
| 1.112 | −0.956 | 5.375 |
| 1.018 | −0.943 | 5.375 |
| 0.925 | −0.924 | 5.375 |
| 0.834 | −0.899 | 5.375 |
| 0.744 | −0.869 | 5.375 |
| 0.655 | −0.835 | 5.375 |
| 0.568 | −0.797 | 5.375 |
| 0.483 | −0.756 | 5.375 |
| 0.399 | −0.712 | 5.375 |
| 0.316 | −0.665 | 5.375 |
| 0.235 | −0.616 | 5.375 |
| 0.155 | −0.565 | 5.375 |
| 0.076 | −0.512 | 5.375 |
| −0.001 | −0.457 | 5.375 |
| −0.078 | −0.401 | 5.375 |
| −0.153 | −0.343 | 5.375 |
| −0.227 | −0.284 | 5.375 |
| −0.300 | −0.224 | 5.375 |
| −0.373 | −0.163 | 5.375 |
| −0.444 | −0.100 | 5.375 |
| −0.515 | −0.037 | 5.375 |
| −0.585 | 0.027 | 5.375 |
| −0.654 | 0.092 | 5.375 |
| −0.723 | 0.158 | 5.375 |
| −0.790 | 0.224 | 5.375 |
| −0.858 | 0.291 | 5.375 |
| −0.924 | 0.359 | 5.375 |
| −0.990 | 0.427 | 5.375 |
| −1.055 | 0.495 | 5.375 |
| −1.120 | 0.565 | 5.375 |
| −1.185 | 0.634 | 5.375 |
| −1.249 | 0.704 | 5.375 |
| −1.312 | 0.775 | 5.375 |
| −1.376 | 0.845 | 5.375 |
| −1.439 | 0.916 | 5.375 |
| −1.501 | 0.987 | 5.375 |
| −1.564 | 1.059 | 5.375 |
| −1.615 | 1.137 | 5.375 |
| −1.576 | 1.216 | 5.375 |

The turbine blade 10 may be fabricated using a casting and machining process. Specifically, in an embodiment of the present disclosure, the turbine blade 10 is cast from a superalloy, including but not limited to a nickel-based superalloy and a cobalt-based superalloy. Examples of acceptable alloys include, but are not limited to, Rene 80, GTD111, and MGA2400.

The airfoil 12 of the turbine blade 10 may also be coated for protection against corrosion. erosion, wear, and oxidation after casting and machining of the airfoil 12. For example, in order to provide increased thermal capability, the airfoil 12 may comprises a ceramic-based thermal coating. As one example, a MCrAlY bond coating of approximately 0.0055 inches thick may be used, where M can be a variety of metals including, but not limited to Cobalt, Nickel, or a Cobalt Nickel mixture.

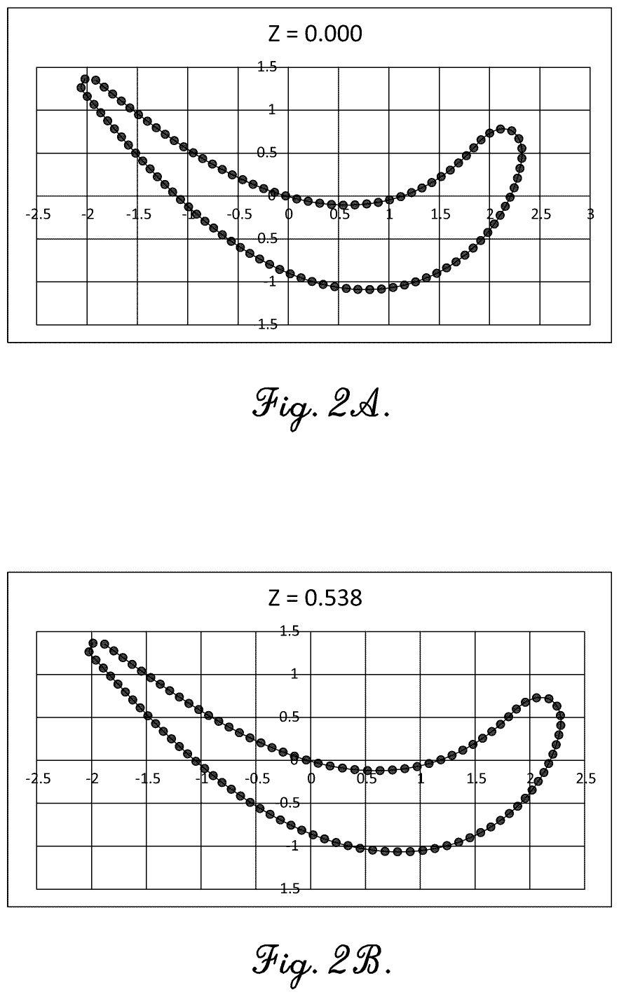

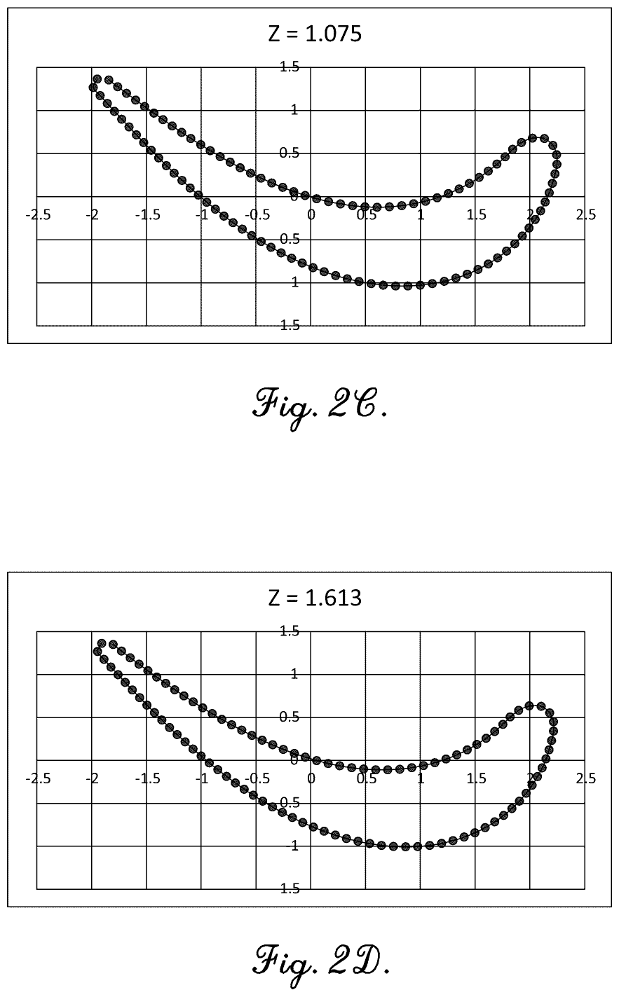

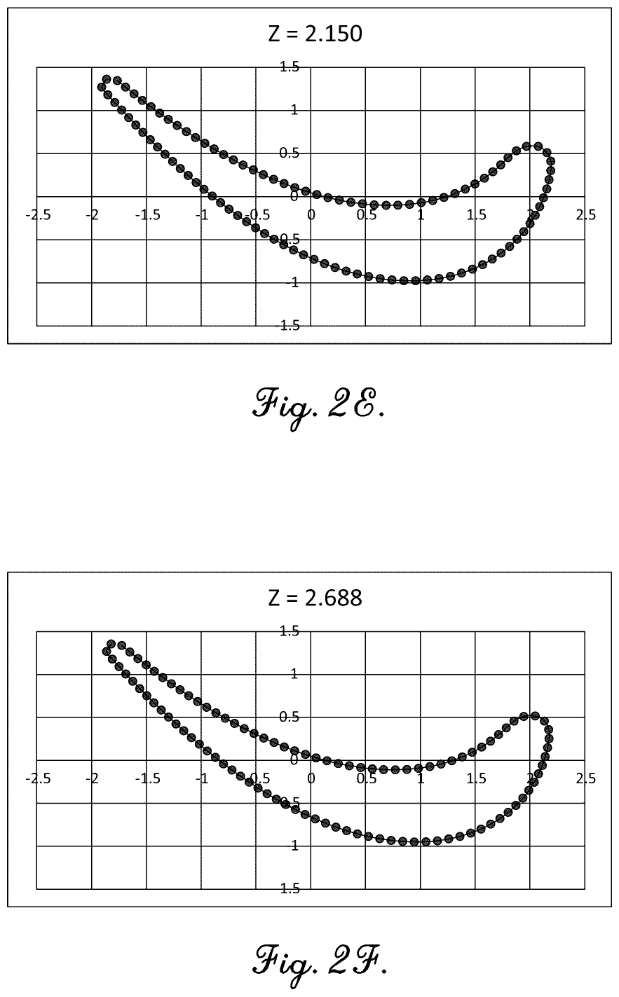

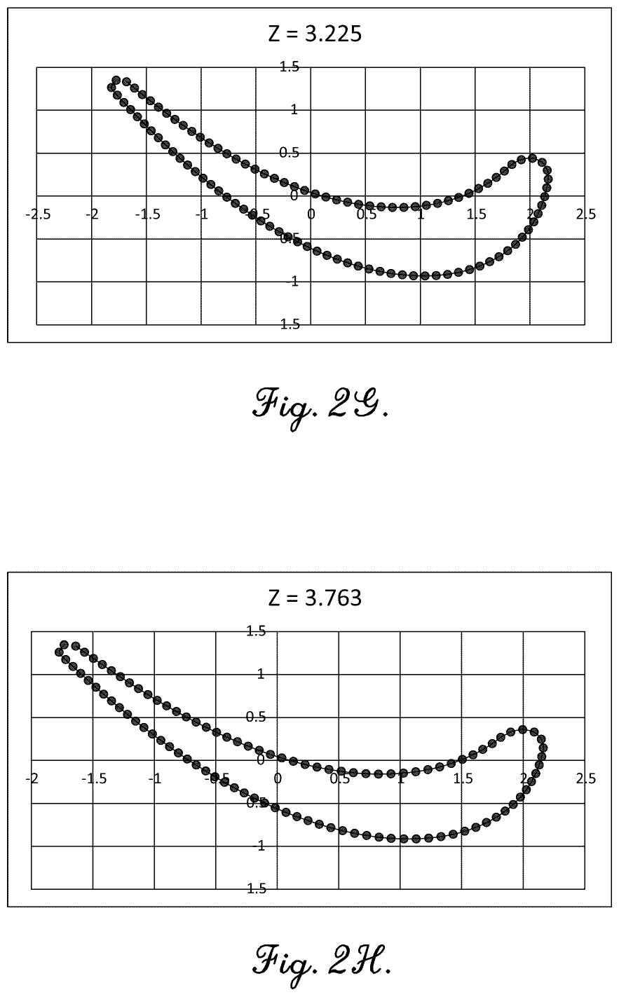

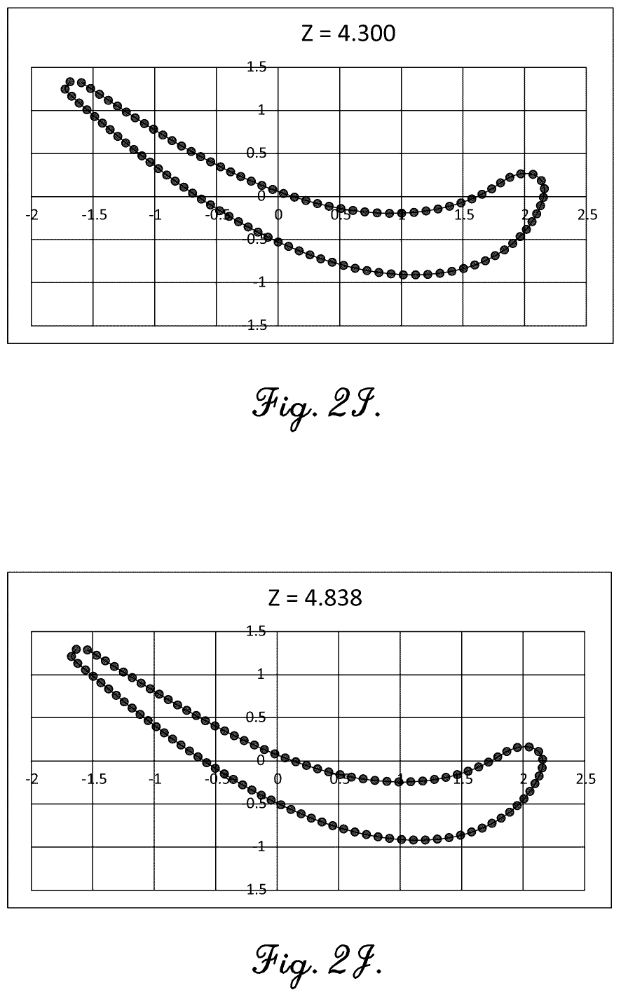

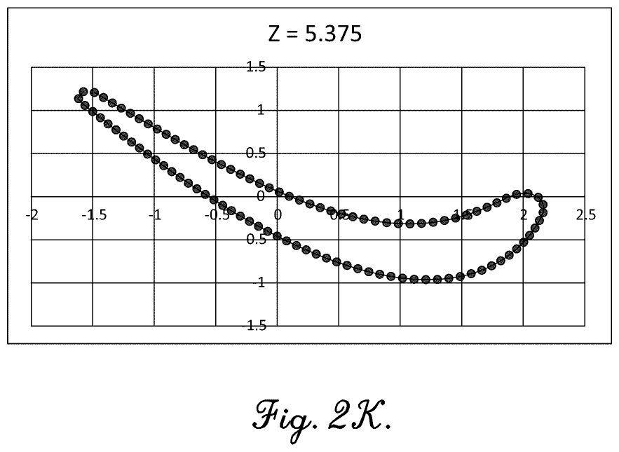

FIGS. 2A-2K show scatter plots of the Cartesian coordinate values of X and Y at different span positions or Cartesian coordinate values of Z. FIG. 2A shows the scatter plot of one hundred Cartesian coordinate values of X and Y at the initial Cartesian coordinate value of Z, i.e., Z=0.000, which is taken at a span location a preselected distance above a fillet 34 where the root end 14 of the airfoil 12 is attached to a radially outer surface of the platform 32. FIGS. 2B-2K show scatter plots of groups of one hundred of the Cartesian coordinate values of X and Y at sequential Cartesian coordinate values of Z=0.538, Z=1.075, Z=1.613, Z=2.150, Z=2.688, Z=3.225, Z=3.763, Z=4.300, Z-4.838, and Z=5.375, which is located at the tip end 16 of the airfoil 12.

The profile or shape of the airfoil 12 is then generated by connecting together the adjacent ones of the non-dimensional Cartesian coordinate values of X and Y, such as shown in the scatter plots FIGS. 2A-2K, by smooth continuing arcs to define a cross-sectional shape of the pressure side 18 and the suction side 20 of the airfoil 12 at each non-dimensional Cartesian coordinate value of Z, with the cross-sectional shapes of the pressure side 18 and the suction side 20 of the airfoil 12 at adjacent ones of the non-dimensional Cartesian coordinate values of Z being joined smoothly with one another to form the airfoil shape along the span of the non-dimensional Cartesian coordinate values of Z, i.e., from Z=0.000 to Z=5.375.

For the embodiment disclosed herein, the airfoil 12 of the turbine blade 10 has a modified profile as compared to prior-art airfoils. In one aspect, the airfoil 12 reduces the incident angle at regions of the airfoil 12 above 75% radial span from the platform 28. Chord lengths between the leading edge 22 and trailing edge 24 of the airfoil 12 are also increased to provide improved guidance for the gas flow exiting the associated turbine stage, which reduces the exit swirl of the turbine stage. As a result of these improvements, the output of the associated turbine stage, which may be the first turbine stage, and the isentropic efficiency are increased.

From the foregoing, it will be seen that this disclosure is one well adapted to attain all the ends and objects set forth above, together with other advantages which are inherent to the system and method. It will be understood that certain features and sub-combinations are of utility and may be employed without reference to other features and sub-combinations. This is contemplated by and within the scope of the claims.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

In the specification and claims, reference will be made to several terms, which shall be defined to have the following meanings. The singular forms “a,” “an,” and “the” include plural references unless the context clearly dictates otherwise.

Approximating language, as used herein throughout the specification and the claim, may be applied to modify any quantitative representation that could permissibly vary without resulting in a change in the basic function to which it is related. Accordingly, a value modified by a term or terms, such as “about” and “substantially” are not to be limited to the precise value specified. In at least some instances, the approximating language may correspond to the precision of an instrument for measuring the value. Range limitations may be combined and/or interchanged. Such ranges are identified and include all the sub-ranges contained therein unless context or language indicates otherwise.

As used herein, the terms “axial” and “axially” refer to directions and orientations extending substantially parallel to a center longitudinal axis of the combustor. The terms “radial” and “radially” refer to directions and orientations extending substantially perpendicular to the axis. Moreover, directional references, such as “side” and similar terms are used herein solely for convenience and should be understood only in relation to each other.

The terms “coupled,” “attached to,” and the like refer to both direct coupling, fixing, or attaching, as well as indirect coupling, fixing, or attaching through one or more intermediate components or features, unless otherwise specified herein.

Although the present application sets forth a detailed description of different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein. without departing from the scope of the disclosure as recited in the claims.

1. A turbine blade comprising:
an airfoil having a root end and an opposite tip end, a pressure side and an opposite suction side, and an airfoil shape defined in accordance with non-dimensional Cartesian coordinate values of X, Y and Z set forth in Table 1,
wherein the non-dimensional Cartesian coordinate values of X, Y and Z are convertible to dimensional distances expressed in a unit of distance by multiplying the non-dimensional Cartesian coordinate values of X, Y and Z by a scaling factor in the unit of distance, wherein the scaling factor is one (1) and the unit of distance is inches,
wherein the non-dimensional Cartesian coordinate values of Z are values on a z-axis that extends in a radial direction from the root end to the tip end of the airfoil, the non-dimensional Cartesian coordinate values of Y are values on a y-axis that extends from the suction side to the pressure side of the airfoil and is orthogonal to the z-axis, and the non-dimensional Cartesian coordinate values of X are values on an x-axis that is orthogonal to the z-axis and to the y-axis,
wherein adjacent ones of the non-dimensional Cartesian coordinate values of X and Y are connected by smooth continuing arcs to define a cross-sectional shape of the pressure side and the suction side of the airfoil at each non-dimensional Cartesian coordinate value of Z, with the cross-sectional shapes of the pressure side and the suction side of the airfoil at adjacent ones of the non-dimensional Cartesian coordinate values of Z being joined smoothly with one another to form the airfoil shape along a span of the non-dimensional Cartesian coordinate values of Z,
wherein the airfoil has manufacturing tolerances of ±0.060 inches.

2. The turbine blade of claim 1, including a base connected to the root end of the airfoil and from which the airfoil extends, the base configured for attachment to a rotor disk in a rotor stage.

3. The turbine blade of claim 2, wherein the turbine blade is a first stage turbine rotor blade.

4. The turbine blade of claim 2, wherein the turbine blade forms part of a first stage of a gas turbine.

5. The turbine blade of claim 1, including a coating applied to the airfoil.

6. The turbine blade of claim 5, wherein the coating is applied to the pressure side and the suction side of the airfoil and comprises a MCrAlY bond coating, where M is a metal.

7. The turbine blade of claim 6, wherein M is Cobalt, Nickel, or a Cobalt Nickel mixture.

8. The turbine blade of claim 1 fabricated from a nickel-based alloy.

9. The turbine blade of claim 1 fabricated from a cobalt-based alloy.

10. (canceled)

11. (canceled)

12. A turbine blade comprising:
an airfoil having a root end and an opposite tip end, a pressure side and an opposite suction side, and an airfoil shape defined in accordance with non-dimensional Cartesian coordinate values of X, Y and Z set forth in Table 1,
wherein the non-dimensional Cartesian coordinate values of X, Y and Z are convertible to dimensional distances expressed in a unit of distance by multiplying the non-dimensional Cartesian coordinate values of X and Y by a scaling factor in the unit of distance and by multiply the non-dimensional Cartesian coordinate value of Z by a different scaling factor in the unit of distance, wherein the scaling factor is one (1) and the unit of distance is inches,
wherein the non-dimensional Cartesian coordinate values of Z are values on a z-axis that extends in a radial direction from the root end to the tip end of the airfoil, the non-dimensional Cartesian coordinate values of Y are values on a y-axis that extends from the suction side to the pressure side of the airfoil and is orthogonal to the z-axis, and the non-dimensional Cartesian coordinate values of X are values on an x-axis that is orthogonal to the z-axis and to the y-axis,
wherein adjacent ones of the non-dimensional Cartesian coordinate values of X and Y are connected by smooth continuing arcs to define a cross-sectional shape of the pressure side and the suction side of the airfoil at each non-dimensional Cartesian coordinate value of Z, with the cross-sectional shapes of the pressure side and the suction side of the airfoil at adjacent ones of the non-dimensional Cartesian coordinate values of Z being joined smoothly with one another to form the airfoil shape along a span of the non-dimensional Cartesian coordinate values of Z,
wherein the airfoil has manufacturing tolerances of ±0.060 inches.

13. The turbine blade of claim 12, including a base connected to the root end of the airfoil and from which the airfoil extends, the base configured for attachment to a rotor disk in a rotor stage.

14. The turbine blade of claim 13, wherein the turbine blade is a first stage turbine rotor blade.

15. The turbine blade of claim 12, including a coating applied to the airfoil.

16. The turbine blade of claim 12, wherein the coating is applied to the pressure side and the suction side of the airfoil and comprises a MCrAlY bond coating, where M is Cobalt, Nickel, or a Cobalt Nickel mixture.

17. The turbine blade of claim 12 fabricated from a nickel-based alloy.

18. (canceled)

19. (canceled)

20. A plurality of turbine blades of claim 12 secured to a rotor disk to form a first stage of a gas turbine.
